(19) United States
(12) Patent Application Publication
(10) Pub. No.: US 2008/0083328 A1
(43) Pub. Date: Apr. 10, 2008

(54) Universal hyperbaric mechanism in engine systems combining general application work machines

(76) Inventor: Marius A. Paul, Yorba Linda, CA (US)

Correspondence Address: RICHARD ESTY PETERSON, Esq., Suite D, 1905 Palmetto Avenue, Pacifica, CA, 94044, US

(21) Appl. No.: 11/546,127

(22) Filed: Oct. 10, 2006

(51) Int. Cl. F02B 75/28

(52) U.S. Cl. 92/69 R

(57) ABSTRACT

A universal hyperbaric mechanism that is integratable into a synergistic engine system with coupled linear machines to extract work in a variety of applications, particularly where the extracted work is equivalent to the linear energy produced, the mechanism having a core cylinder divided into multiple cylinders by double acting double piston assemblies having a cross arm linking mechanism connecting a crank for coordinating the reciprocation action of the piston assemblies where operation is optimized by integration with a thermal electric gas turbine assembly.

### BACKGROUND OF THE INVENTION

The universal hyperbaric mechanism and synergistic system of this invention is designed for general applications where extremely high pressures are required. The hyperbaric mechanism is designed for direct transfer of mechanical energy from a thermal engine system to the receiving mechanism in a synergistic system of high efficiency.

In many industries, extremely high pressure systems are required. The universal hyperbaric mechanism is a versatile thermal engine system that can utilize an internal or external heat source to generate a linear or rotary output for application to machines that operate in an ultra high-pressure working cycle, such as pumps and compressors for compressible and incompressible fluids, compound thermal electric machines both linear and rotary, and other devices that can be coupled with the basic hyperbaric mechanism in a synergistic system.

For example, in the petrochemical industry, processes such as gas liquification or high pressure liquid reactions require a means to develop pressures over 3,000 bars. With a means for direct transfer of force and power from the engine at a hyperbar of 300 and with a 10 to 1 multiplication of the pressure to the compressor stage, a pressure of 3,000 bar is achieved without multiple intermediate stages and mechanisms typically including multimegawatt electric machines.

The thermal efficiency of any thermal machines producing work is directly related to the maximum pressure ratio capable of being created in the process of compression, combustion and expansion. Conventional gas turbines have 25-30 to one pressure ratios and have a thermal efficiency of 30% or less. Spark ignited engines typically have compression ratios of 8-10 to one, limited by the octane number of the gasoline, and have a thermal efficiency of 20-25%. Diesel engines running at 100-125 to one pressure ratios achieve a thermal efficiency of 35%. By comparison, by running at many hundreds or thousands of bar pressures, the universal hyperbaric mechanism can achieve thermal efficiencies up to 80%-90%.

### SUMMARY OF THE INVENTION

The cornerstone of the synergistic hyperbaric system of this invention is the universal hyperbaric mechanism which incorporates and integrates double-action opposed piston assemblies, counteracting engine cylinders, and cooperating components such as compressors, pumps and any forms of variable displacement and multi-stage working systems, including linear or rotary, mechanical or electric machines.

The integrated systems disclosed are representative of the synergistic systems contemplated for the variety of often application specific mechanisms desired. The engine cylinders and piston assemblies are of a type that were developed and demonstrated in the ultra high pressure engine technologies described in earlier Paul, et al. patents, such as U.S. Pat. No. 4,841,928, entitled Reciprocal Engine with Floating Liner, issued Jun. 27, 1989 and U.S. Pat. No. 5,056,314, entitled Internal Combustion Engine with Compound Air Compression, issued Oct. 15, 1991.

The novel direct differential transfer of forces from the hyperbaric engine pistons to multi-staged compressor pistons is the essence of the hyperbaric pressure multiplication process for certain of the described ultra high pressure systems. The process is accomplished without any forms of complex intermediate assemblies including mechanical transmissions or electrical machines.

The synchronization of the working sub-systems is under the controlled action of the novel cross arm transfer mechanism that includes two connecting rods and one crankshaft and functions as key component in the various embodiments described.

The reciprocating sub-systems of hyperbaric working machines and hyperbaric compressors are beneficially associated with hyperbaric, turbo electric, compound counter rotating compressors and gas turbines of the type described in earlier Paul, et al. patents, such as U.S. Pat. No. 6,751,940, entitled Efficiency Gas Turbine Power Generator, issued Jun. 22, 2004, and U.S. Pat. No. 6,725,643, entitled High Efficiency Gas Turbine Power Generator Systems, issued Apr. 27, 2004.

Additionally, the pistons of the hyperbaric engines and compressors are preferably sealed with piston rings of the type described in Paul, et al., U.S. Pat. No. 4,809,646, entitled High Pressure Reciprocator Components, issued Mar. 7, 1989, incorporated herein by reference.

The ultra supercharging level produced by the turbo electric compound systems of certain of the referenced patents can in one stage of counter rotating compressors with isothermal compression create 30 to 1 pressure ratios, and in two stages up to 300 to 1 pressure ratios.

An essential characteristic of the novel synergetic systems is the direct transfer of forces from the engine pistons by direct linear links to the work application in the form of machines, such as compressors, pumps, linear electric machines, mechanical and hydraulic machines and other power intensive mechanisms. With the cross arm transfer mechanism, the power transferred to the crankshaft is minimized and the primary mission of the transfer mechanism is limited to synchronization.

The embodiments of this invention represent in part a synergetic association and integration of earlier Paul inventions with a mechanism to achieve new levels of ultra high pressure operation and a maximization of thermodynamic efficiency. The unique embodiments described provide examples of maximized power density for multiple, double-action opposed piston engines, capable of reaching a maximum pressure ration and thermal efficiency.

### BRIEF DESCRIPTION OF THE DRAWINGS

FIG. 1 is a schematic view of schematic view of the universal hyperbaric mechanism in the form of a thermal engine system with three double acting reciprocating piston assemblies and a gas turbine assembly.

FIG. 2 is a schematic view of the universal hyperbaric mechanism of FIG. 1 modified with linear power machines.

FIG. 3 is a schematic view of the universal hyperbaric mechanism of FIG. 2 with four cylinders and three double acting reciprocating piston assemblies, including linear power machines.

FIG. 4 is a schematic view of the universal hyperbaric mechanism of FIG. 3 with ultra high pressure, differential stage linear compressors and other linear power machines.

FIG. 5 is a schematic view of the universal hyperbaric mechanism in an engine system at maximum potential, forming multi symmetric synergetic engine.

### DETAILED DESCRIPTION OF THE PREFERRED EMBODIMENTS

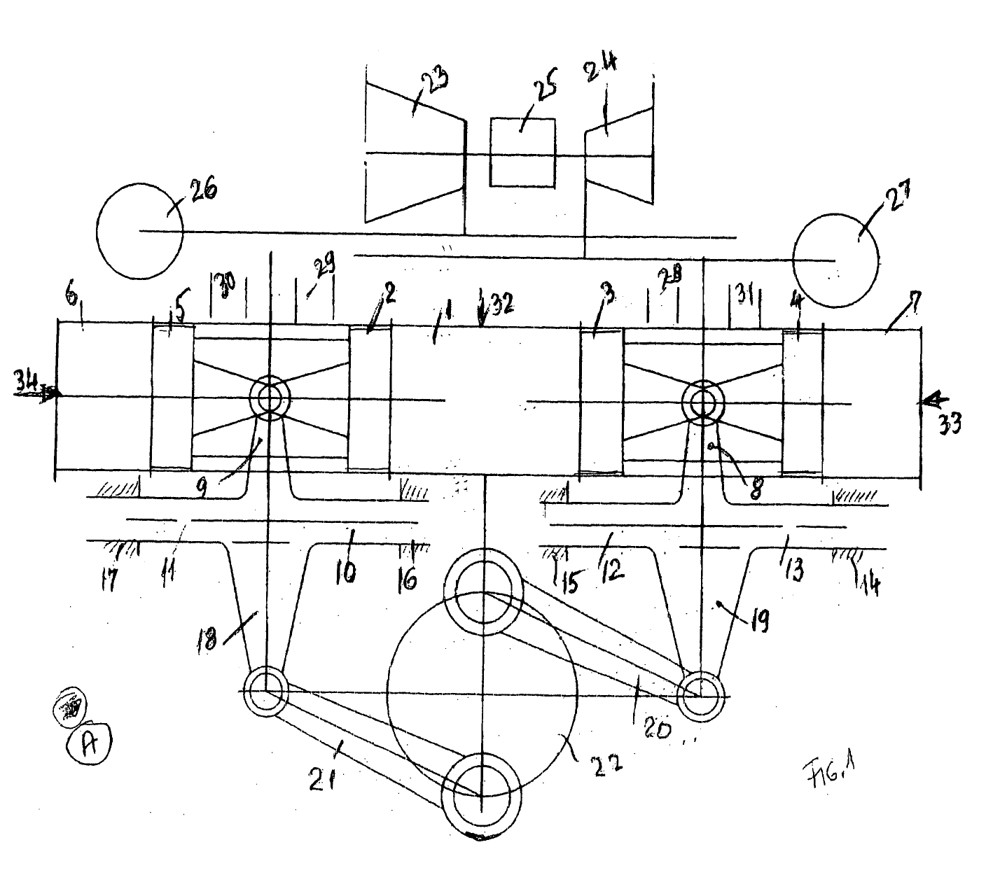

In FIG. 1, the universal hyperbaric mechanism, generally referenced by A, is an engine system with a central cylinder 1 with two opposed pistons 2 and 3, having opposed piston faces 4 and 5 acting in the opposite end cylinders 6 and 7. The pistons 2, 3, 4 and 5, are articulated with cross arms 8 and 9, provided with cross bars 10, 11, 12 and 13, that reciprocate in guides 14, 15, 16, 17. The cross arms 8 and 9 are also provided with extended connecting arms 18 and 19, which are pivotally linked with connecting rods 20 and 21 that drive the crankshaft 22. The sliding cross bars 10, 11, 12 and 13 in the guides 14, 15, 16 and 17, control the torque during operation. The engine assembly A is also associated with a thermal electric gas turbine assembly having a gas turbine 23, a compressor 24, and an electric machine 25. The exhaust gases from the linear engine subsystem are collected in the exhaust reservoir 26 drive the turbine 23 and the supercharging air is collected in the reservoir 27 for supply to the reciprocator.

The intake and exhaust for the central cylinder 1 are provided by port 28 for intake, and port 29 for combined intake and exhaust. The ports 30 and 31 are combined intake and exhaust ports for the opposite end cylinders 6 and 7. The central cylinder 1 is provided with fuel injectors 32, and the opposite end cylinders 6 and 7 are provided with fuel injectors 33 and 34. The sliding pistons 2, 3, 4 and 5 in these three cylinders are in permanent energy reciprocation with symmetric alternate cycles of compression and expansion perfectly dynamically balanced with zero inertial forces or vibrations. The combined power of the engine is produced by the totality of the actions provided by the engines' linear, and rotary members converted into mechanical and electrical power as required and as supplemented by the electrical power resulting from a positive balance of energy from the optimally operated gas turbine 23.

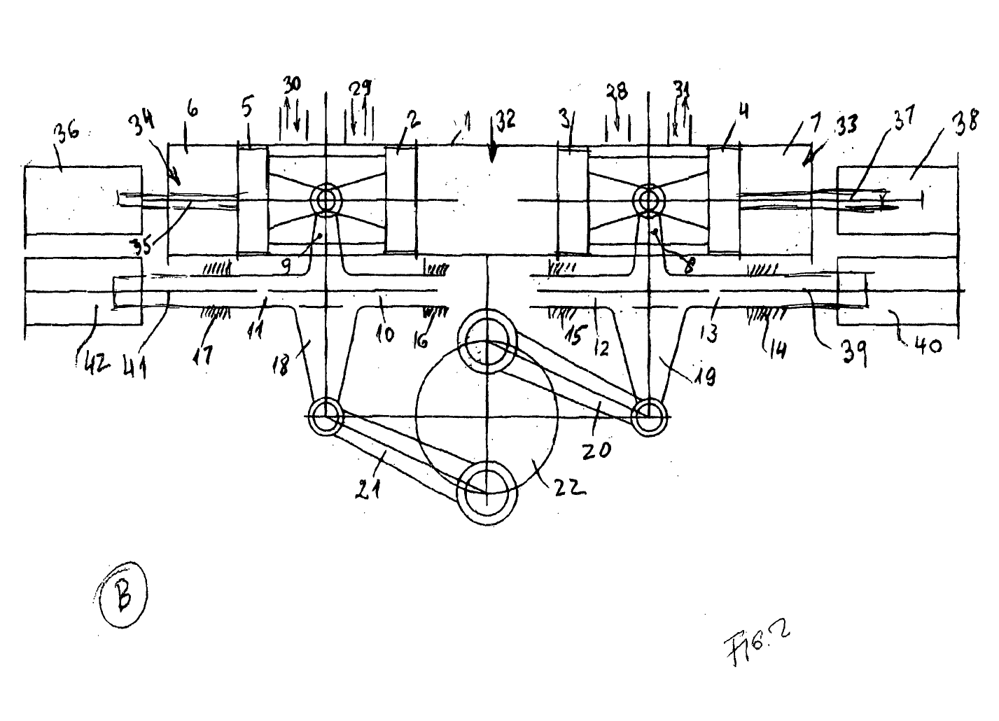

In FIG. 2, the engine system A described in FIG. 1 is modified and is generally indicated by B, wherein the transfer of power is made by linear links 35, 37, 39 and 41 to linear machines 36, 38, 40 and 42, which can be linear electric generators and/or any type of linear reciprocator machine that can use all the power produced.

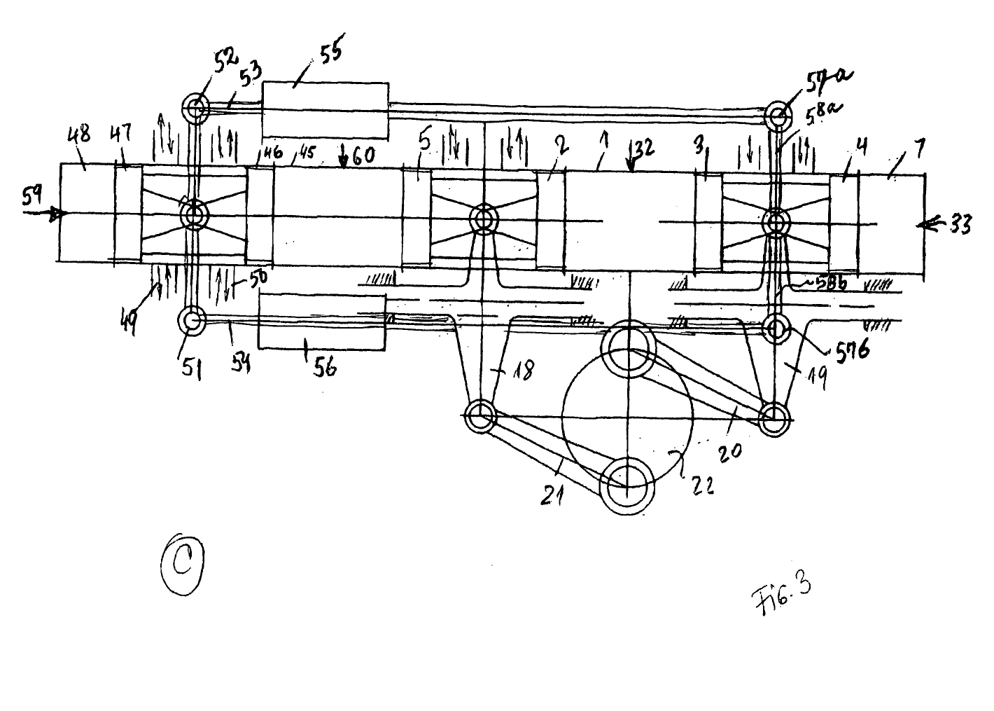

In FIG. 3, the same engine system A described in FIG. 1 is modified and is generally indicated by C, wherein an additional engine cylinder 45 is located with a counter opposed piston 46 and double action piston 47, acting in opposite end cylinder 48, provided with combined intake-exhaust ports 49 and 50.

The articulated cross arms 51, 52, are connected with links bars 53 and 54, associated with the linear machines 55 and 56, connected by the articulation mounts 57a and 57b, with the cross arms 58a, 58b of the assembly with the double pistons 3 and 4.

The universal hyperbaric mechanism has four active engine cylinders with pistons acting two by two in double faced operations of opposed pistons in permanent dynamic balance, the two outer assemblies of double acting pistons counteracting the central assembly of double acting pistons. The central two cylinder opposed piston engine segment is working with a single flow, total intake-exhaust scavenging system, and the opposite end cylinders are working with loop scavenging total intake-exhaust system. The outer double faced pistons 3, 4, 46 and 47 are working in tandem, connected by the bars 53, 54, whereby the engine system has in totality six active piston faces.

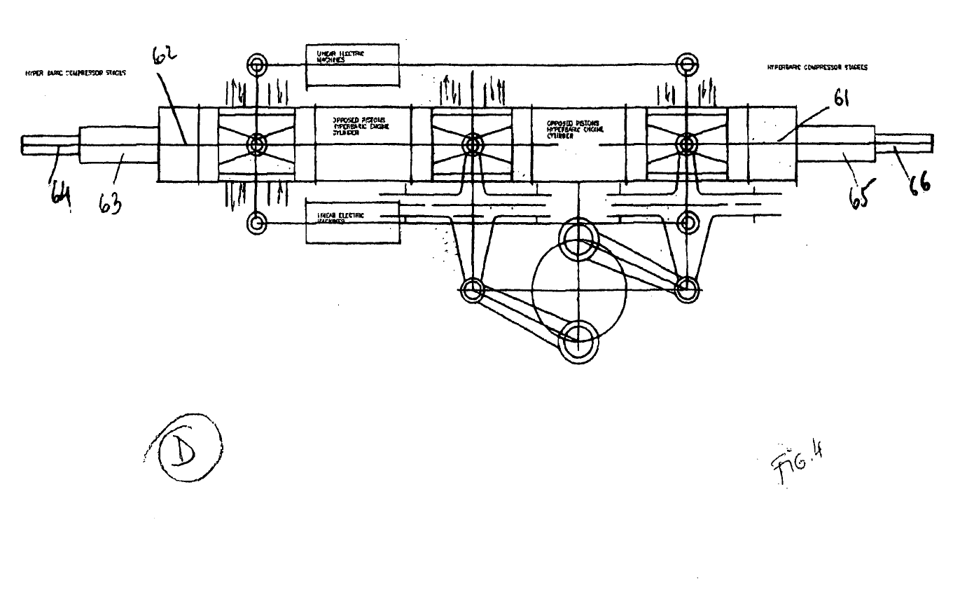

In FIG. 4, the same engine system described in FIG. 3 is modified and generally indicated by D, wherein additional projecting end bars 61 and 62 are activating differential compressors 63, 64, 65, 67 for production of ultra high pressure gases or liquids.

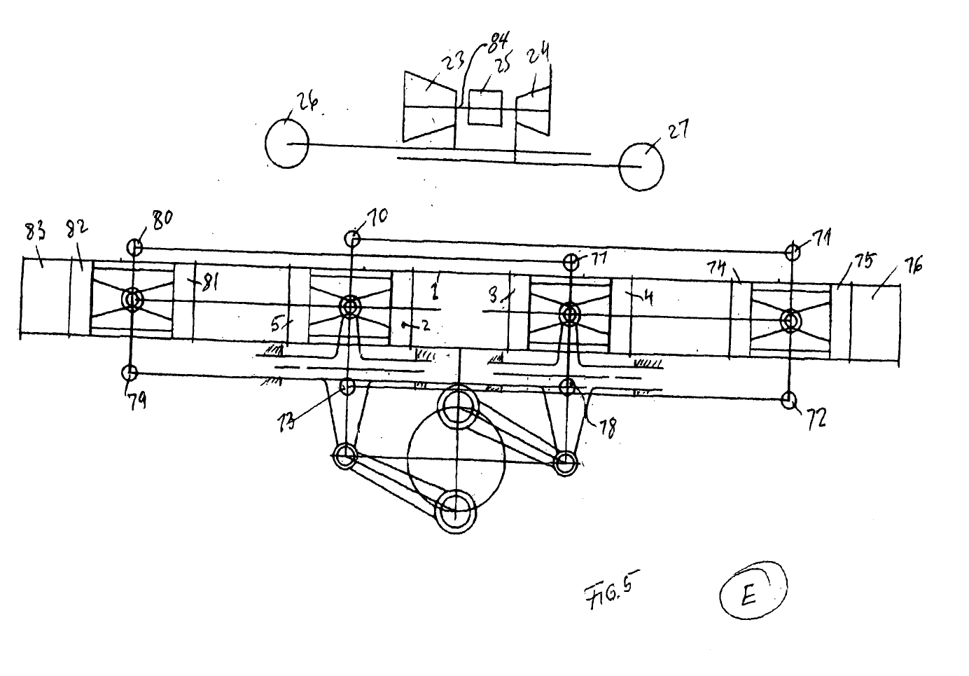

In FIG. 5, the symmetric and synergetic engine system, generally indicated by E, has an engine core of the universal hyperbaric engine type described in FIG. 1 in which an additional two tandem symmetric pistons and cylinders are added and activated by two quadrilateral mechanisms shown schematically. The first quadrilateral mechanism is an assembly of articulated bars 70-71 and 72-73, connecting the assembly of double acting pistons 2 and 5 with the tandem double acting pistons 74, 75. The second quadrilateral mechanism is an assembly of articulated bars 77-78 and 79-80, connecting the assembly of double acting pistons 3 and 4 with the tandem double acting pistons 81, 82. Finally, each quadrilateral mechanism is reciprocating in the extreme opposite end cylinders 76 and 83. This engine system E with five activated engine cylinders and four assemblies of double acting pistons forms the highest level of power density with more than 1,000 hp/liter at the highest levels of pressure ratio 300/1-500/1, with a supercharging level of 10-20 and the highest thermal efficiency of 80%-90%.

Again, the energetic system of FIG. 5 is a turbo electric compound system with the integration of the basic engine assembly with an exhaust energy recovery system 26 and the associated gas turbine assembly with an ultra high pressure supercharging system of compressor 24, electric machine 25 and air reservoir 27. The quadrilateral system of FIG. 5 is the most flexible linear collector, carrier and supplier of power produced by all the engine reciprocator assemblies and cylinders available for use by linear electric power generators and other preferably linear devices. A substantial part of the power is delivered by the gas turbine with the electric machine 25 operating as a power generator on a shaft 84 co-axial with the gas turbine shaft. The driving crank shaft mechanism is reduced to the level of synchronizer with residual rotary mechanical power for starting the engine.

1. A universal hyperbaric engine comprising:
a reciprocating mechanism with two opposed pistons and two connected pistons, one connected piston connected to one of the opposed pistons and the other connected piston connected to the other of the opposed pistons;
a common cylinder in which the opposed pistons are reciprocated in opposite directions, and two end cylinders in which the end pistons are reciprocated, the common cylinder and end cylinders having an identical axis; and,
two sliding cross bars with arms, cross-bar, guides and a crank assembly, wherein the cross bars slide in the cross-bar guides on axes parallel to the axis of the cylinders, wherein the cross arm of one cross bar is connected to a first of the connected end piston and opposed piston and the cross arm of the other cross bar is connected to a second of the connected end piston and opposed piston, and wherein both cross arms are also connected to the crank assembly for a coordinated reciprocation.
